(19) United States
(12) Patent Application Publication
(10) Pub. No.: US 2005/0206942 A1
(43) Pub. Date: Sep. 22, 2005

(54) Image forming apparatus

(75) Inventor: Masafumi Hayakawa, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Oki Data Corporation

(21) Appl. No.: 11/081,920

(22) Filed: Mar. 16, 2005

(30) Foreign Application Priority Data
Mar. 16, 2004 (JP) 2004-074674

(51) Int. Cl. G06F 15/00

(52) U.S. Cl. 358/1.14

(57) ABSTRACT

What is disclosed is an image forming apparatus having a data processing section for sending the received data put out from a host apparatus to a printing section comprising: an electricity source changing section for turning on or off the main electricity source; a turning off arranging signal generating section for putting out a signal for arranging turning off the main electricity source; a memory section for storing the received data temporarily; a data editing section for reading out the received data from the memory section, and for expanding and editing the received data, so as to put out print data; a data storing detecting section for detecting completion of storing the received data; a printing completion detecting section for detecting completion of printing data; a turning off controlling section for starting a process for turning off the image forming apparatus, and for stopping power supply from the main electricity source.

### BACKGROUND OF THE INVENTION

1. Field of the Invention

The present invention relates to an image forming apparatus such as a printer, a facsimile or a copy machine etc. especially to an image forming apparatus which is able to perform a printing process of a received data adequately when it is turned off for a maintenance work.

2. Description of Related Art

In today's ordinary computer system, plural host apparatuses such as personal computers and a printer of high performance are connected with LAN. Thereby, in case where each data of the plural host apparatus are printed out on recording sheets, each of data are sent to a printer commonly used where a printing process is performed (c.f. JP2002-236528).

However, in case where the main electricity source is turned off in this kind of image forming apparatus represented by a printer mentioned above when a host apparatus is sending data to the printer, in order to perform a maintenance work for periodical check or for unexpected trouble; a user of the host apparatus must confirm interruption of forming image, and he must send again the data before the interruption for forming image. Moreover, in case of receiving image data for forming a picture, the user must send all the data again when the electricity source is turned off. Especially, in a network system where many users use a high performance printer in common, the interruption of receiving data in forming image decreases efficiency of the user's work, on the other hand, delaying the maintenance work until completion of forming image corresponding to all the host apparatuses wastes time and money for the maintenance work.

The object of the present invention is to provide an image forming apparatus which is able to perform printing image data received from each host apparatus in case where a maintenance work is performed, and which is able to avoid wasting time and money for the maintenance work caused by delaying the maintenance work until completion of printing.

### SUMMARY OF THE INVENTION

According to one aspect of the present invention, there is provided an image forming apparatus (1) operated with receiving power supply from a main electricity source, and having a data processing section for sending the received data put out from a host apparatus to a printing section after processing the received data to print data, comprising: an electricity source changing section for turning on or off said main electricity source; a turning off arranging signal generating section for putting out a signal for arranging turning off said main electricity source; a memory section for storing the received data temporarily; a data editing section for reading out said received data from said memory section, and for expanding and editing said received data, so as to put out print data; a data storing detecting section for detecting completion of storing said received data in said memory section; a printing completion detecting section for detecting completion of printing data in said printing section; and a turning off controlling section for starting a process for turning off the image forming apparatus, with receiving said signal from said turning off arranging signal generating section, and for stopping power supply from said main electricity source, with receiving a signal from said receiving completion detecting section informing of completion of receiving, and with receiving a signal from said printing completion detecting section informing of completion of printing.

As mentioned above, in the image forming apparatus mentioned above, for beginning a maintenance work, the turning off controlling section reads a signal for arranging turning off of the electricity source and it starts a process of controlling turning off. Then, data in printing at the printing section is print out on record sheets; on the other hand, each EOF command of each receiving data is detected, and the receiving data after detecting the EOF command is rejected. That is, even when power supply from the main electricity source is stopped for a maintenance work, the image forming apparatus is able to confirm which data is printed out, and it is able to automatically print out data not printed out because of turning off, at a time of re-starting the apparatus with turning on.

Moreover, an image forming apparatus (2) according to (1) further comprising: an expanding completion judging section for putting out a signal to said data editing section for stopping process of expanding and editing, based on arrangement of turning off made by said turning off controlling section, after receiving information from said receiving completion detecting section informing of completion of receiving.

As mentioned above, the image forming apparatus (2) interrupts process of expanding and editing data in the data editing section when it confirms each EOF command of each received data. And, it waits for the printing section to complete printing, after interrupting process of expanding and editing data in the data editing section. Then, it stops the printing section after confirming completion of printing. Thereby, even after starting a process for maintenance work, the time of printing at the printing section is prolonged, and the received data stored in the memory section is read out to print out. Therefore, necessary memory capacity for storing the received data becomes the least. Moreover, after finishing the maintenance work, when the apparatus starts operating with turning on the main electricity source, the time for completing the received data stored in the memory section becomes short, and a receiving data after re-starting with turning on the main electricity source is quickly printed out.

Moreover, an image forming apparatus (3) according to (1) further comprising: a canceling signal detecting section for detecting a canceling signal of canceling said signal of turning off generated from said turning off arranging signal generating section.

As mentioned above, the image forming apparatus (3) is able to cancel arrangement of turning off the main electricity source directed by the turning off controlling section for a maintenance work by detecting a canceling signal for canceling turning off signal of the turning off arranging signal generating section.

Moreover, an image forming apparatus (4) according to (1) further comprising: a receiving number detecting section for detecting the number or quantity of the received data.

As mentioned above, the image forming apparatus (4) is able to cancel arrangement of turning off based in judgement of a user if the number or quantity of the received data detected by the receiving number detecting section can be presented at a presenting section, so as to increase availability. Moreover, it is able to cancel arrangement of turning off based on a result of detection, if the number or quantity of the received data to be canceled is set beforehand.

Moreover, an image forming apparatus (5) according to (4) wherein: said turning off controlling section has a reference number or quantity, for turning on or off said main electricity source, based on the number or quantity of the received data detected by said receiving number detecting section.

As mentioned above, the image forming apparatus (5) is able to quickly stop receiving data and to turn off the main electricity source, the number of the received data becomes more than a prescribed number after arranging turning off, as a total number of the received data is detected.

Moreover, an image forming apparatus (6) according to (1) wherein: said memory section has a non-volatile memory.

As mentioned above, the image forming apparatus (6) is able to decrease memory capacity of the memory section when the received data stored in the memory section is deleted.

According to another aspect of the present invention, there is provided an image forming apparatus (7) operated with receiving power supply from a main electricity source, and having a data processing section for sending the received data put out from a host apparatus to a printing section after processing the received data to print data, comprising: an electricity source changing section for turning on or off said main electricity source; a turning off arranging signal generating section for putting out a signal for arranging turning off said main electricity source; a memory section for storing the received data temporarily; a data editing section for reading out said received data from said memory section, and for expanding and editing said received data, so as to put out print data; a data storing detecting section for detecting completion of storing said received data in said memory section; a printing completion detecting section for detecting completion of printing data in said printing section; an individual turning off controlling section for starting a process for turning off the image forming apparatus, with receiving said signal from said turning off arranging signal generating section, and for stopping power supply from said main electricity source, with receiving a signal from said receiving completion detecting section informing of completion of receiving, and with receiving a signal from said printing completion detecting section informing of completion of printing; and an electricity source changing section for changing power supply from said main electricity source between said data processing section and said printing section.

As mentioned above, the image forming apparatus (7) is able to save power supply by turning off either of the data processing section or the printing section quickly, by controlling turning on and off of the data processing section and the printing section individually according to state of operation of the data processing section and the printing section.

Moreover, an image forming apparatus according to Claim 7 wherein:

said memory section has a non-volatile memory.

As mentioned above, the image forming apparatus (8) is able to decrease memory capacity of the memory section when the received data stored in the memory section is deleted, as well as (6).

### BRIEF DESCRIPTION OF THE DRAWINGS

FIG. 1 is a block diagram showing a configuration of an image forming apparatus of Embodiment 1 of the present invention;

FIG. 2 is a flow chart showing an operation of Embodiment 1;

FIG. 3 is a flow chart showing an operation of Embodiment 1;

FIG. 4 is a block diagram showing a configuration of an image forming apparatus of Embodiment 2 of the present invention;

FIG. 5 is a flow chart showing an operation of Embodiment 2;

FIG. 6 is a block diagram showing a configuration of an image forming apparatus of Embodiment 3 of the present invention;

FIG. 7 is a flow chart showing an operation of Embodiment 3;

FIG. 8 is a block diagram showing a configuration of an image forming apparatus of Embodiment 4 of the present invention;

FIG. 9 is a flow chart showing an operation of Embodiment 4;

FIG. 10 is a block diagram showing a configuration of an image forming apparatus of Embodiment 5 of the present invention with another aspect;

FIG. 11 is a flow chart showing an operation of Embodiment 5.

### DESCRIPTION OF THE PREFERRED EMBODIMENTS

Before beginning a maintenance work, a signal from a switch of arranging turning off, is outputted by pressing the switch. A turning off controlling section which has received the signal judges each state of the data processing section and the printing section individually. That is, it judges whether the data processing section is receiving data or not, and whether the printing section is printing the data. Then, the received data is printed out quickly. And, a coming data from each host apparatus is rejected.

### <EMBODIMENT 1>

<Configuration>

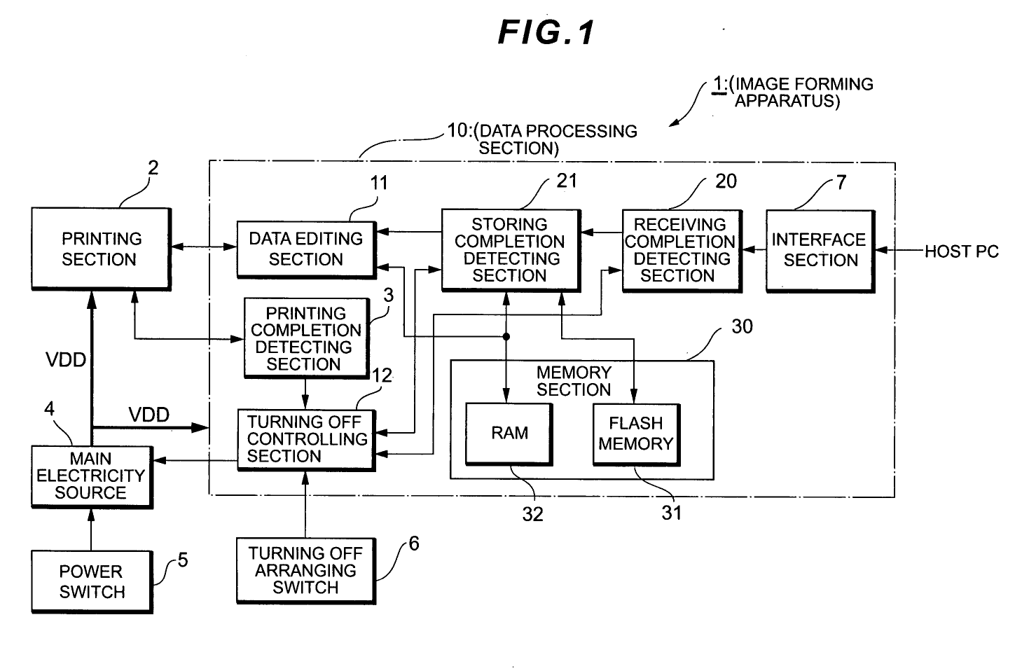

FIG. 1 is a block diagram showing a configuration of an image forming apparatus of Embodiment 1 of the present invention. The image forming apparatus 1 of Embodiment 1 has a data processing section 10. The data processing section 10 comprises each of blocks shown in FIG. 1 and CPU not shown in FIG. 1 for performing an overall control of the blocks. Moreover, the image forming apparatus 1 has a printing section 2 for performing a printing of print data such as image data put out from the data processing section 10. A main electricity source 4 provides an electric power to the data processing section 10 and to the printing section 2. Then, an operator is able to turn on or off the main electricity source 4 by operating a power switch 5.

The data processing section 10 is connected via an interface section 7 to a host device not shown in FIG. 1 such as a personal computer (PC) etc. A receiving completion detecting section 20 installed in the data processing section 10 detects each EOF (End Of File) command in each data such as image data from the host device received at the interface section 7. Thereby, it is able to detect each completion of the data. Moreover, the data processing section 10 has a memory section 30 comprising a flash memory 31 and a RAM 32 for storing temporarily the data received by the receiving completion detecting section 20. And, the data processing section 10 has a storing completion detecting section 21 for detecting completion of storing the received data in the flash memory 31 of the memory section 30.

Moreover, the data processing section 10 has a data editing section 11 for transforming the received data read out from a RAM 32 of a memory section into a printing data, by performing an editing process of compression, expansion, image transformation etc. Further, the data processing section 10 has a turning off controlling section 12 which is an essential part of the image forming apparatus of Embodiment 1. A turning off arranging switch 6 is connected to the turning off controlling section 12. This is a switch operated by a maintenance staff for generating a signal of arranging a turning off that is sent to the turning off controlling section 12. Thereby, the maintenance staff is able to inform to the turning on controlling section 12 that a maintenance work will be performed to the image forming apparatus 1.

The turning off controlling section 12 with receiving the signal from the turning off arranging switch 6, starts watching a receiving completion detecting section 20, a storing completion detecting section 21 and a printing completion detecting section 3. When the receiving completion detecting section 20 receives a watching signal from the turning off controlling section 12, it puts out a reply signal to the turning off controlling section 12 informing that data receiving is completed and that EOF command in each data is detected. When the storing completion detecting section 21 receives a watching signal from the turning off controlling section 12, it puts out a reply signal to the turning off controlling section 12 informing that each of the received data are stored in the flash memory 31 of the memory section 30. And, when the printing completion detecting section 3 receives a watching signal from the turning off controlling section 12, it puts out a reply signal to the turning off controlling section 12 informing that the printing section 2 has stopped after a printing process by the printing section 2 is completed.

<Operation>

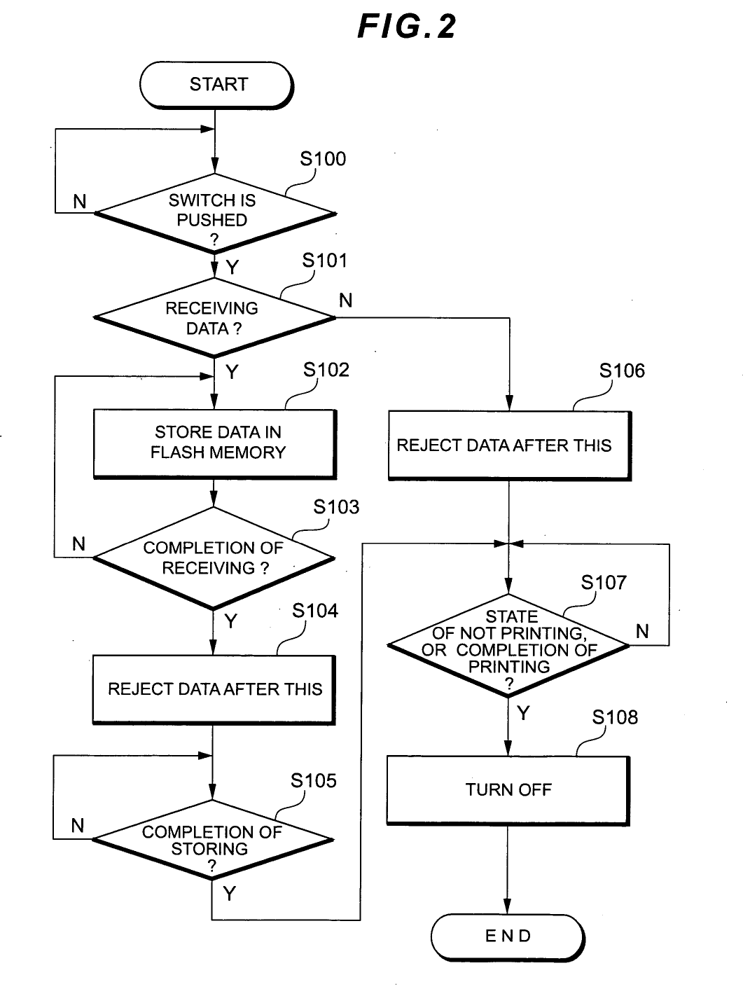

Subsequently, an operation of Embodiment 1 will be described referring to FIG. 2.

In order to prepare for a maintenance work to be performed, first of all, the turning off arranging switch 6 is pushed by a maintenance staff (STEP S100). Thereby, a signal of arranging turning off of the image forming apparatus 1 is put out to the turning off controlling section 12. When the turning off controlling section 12 receives the signal, it starts a process of the present invention. And, the turning off controlling section 12 inquires the interface section 7 whether it is receiving a data such as an image data etc. or not (STEP S101). When the interface section 7 is receiving a data, the process of the turning off controlling section 12 proceeds to the next step S102. When the interface section 7 is not receiving a data, the process of the turning off controlling section 12 proceeds to the step S106.

When the interface section 7 is receiving a data at step S101, the memory section 30 is storing the receiving data in the flash memory 31 (STEP S102). The storing completion detecting section 21 searches each EOF command of each storing data in the flash memory 31 (STEP S103). When the storing completion detecting section 21 detects all the EOF commands in the flash memory 31, receiving all the data now receiving is completed. The receiving completion detecting section 20 detects this. Then, the receiving completion detecting section 20 puts out a signal of completion of receiving to the turning off controlling section 12. When the turning off controlling section 12 receives the signal of completion of receiving, it puts out a signal for indicating not to receive any other data. By receiving the indicating signal at the receiving completion detecting section 20, any other data is not received at the interface section 7 (STEP S104). Moreover, the storing completion detecting section 21 is searching the RAM 32 of the memory section 30 to detect EOF commands stored or not (STEP S105). When the storing completion detecting section 21 detects completion of storing, the process proceeds to a step S107. There, the printing completion detecting section 3 watches whether the printing section 2 is performing printing or not. When the printing section 2 is performing printing, the printing completion detecting section 3 watches until stop of the printing section 2 after completion of printing. When the turning off controlling section 12 receives information of stop of the printing section 2 after completion of printing from the printing completion detecting section 3, it puts out a control signal for turning off the main electricity source 4, so as to stop power supply of the main electricity source 4 (STEP S108).

When the interface section 7 is not receiving a data at step S101, the turning off controlling section 12 receives a signal of no data receiving from the interface section 7. Then, the turning off controlling section 12 puts out an indicating signal to the interface section 7 of not receiving data any more (STEP S106). Succeedingly, the process proceeds to the step S106 mentioned above, so as to perform the same steps. That is, when the turning off controlling section 12 receives information of stop of the printing section 2 after completion of printing from the printing completion detecting section 3, it puts out a control signal V for turning off the main electricity source 4, so as to stop power supply of the main electricity source 4 (STEP S108).

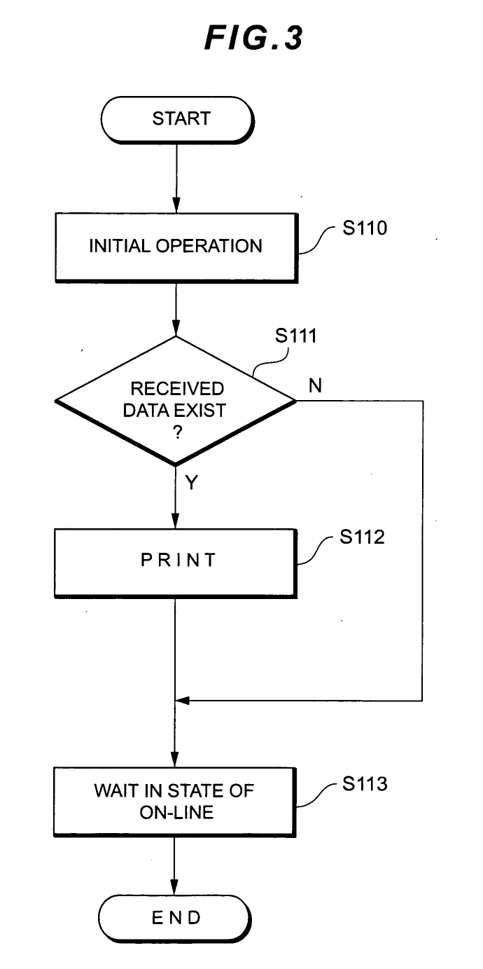

Moreover, in a flow chart of FIG. 3, a power switch 5 is operated by the maintenance staff after maintenance work, to turn on the main electricity source 4 and to perform an initial operation (STEP S110). After that, whether the received data remain or not is judged (STEP S111). When the received data remain, printing process is performed by the printing section 2 (STEP S112). When the received data do not remain, the printing section 2 waits for printing process (STEP S113).

<Effects>

According to Embodiment 1, effects are obtained as follows.

(a) In case where a maintenance work is performed, when the turning off arranging switch 6 is pushed, data being printed at that time is printed out onto sheets let out, and data not received at that time is not received by rejecting data after detecting all the EOF commands of each received data.

(b) When the electricity source is turned off for a maintenance work in the course of printing, in the conventional art, the maintenance staff must confirm which part of the received data has been printed. However, in the present invention, the maintenance staff does not need to perform such confirmation. And, he does not need to send again a part of the received data not printed by turning off.

(c) When the staff begins a maintenance work, he does not need to adjust timing for turning off the apparatus. And, he can perform a maintenance work quickly with the best timing.

### <EMBODIMENT 2>

<Configuration>

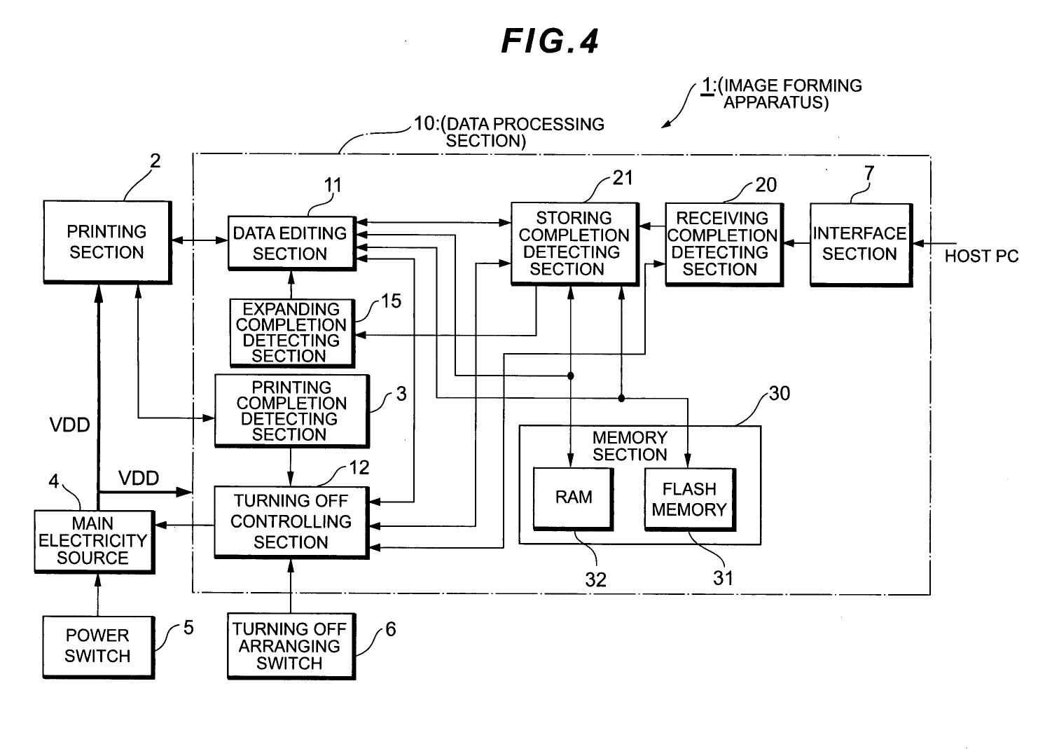

FIG. 4 is a block diagram showing a configuration of an image forming apparatus of Embodiment 2 of the present invention based on Embodiment 1. Each block same as Embodiment 1 is designated with the same symbol as Embodiment 1, so as to omit the same description. In Embodiment 2, the data processing section 1 is installed with an expanding completion detecting section 15. Thereby, whether a process of expanding or editing performed by the data editing section 11 is completed or not is detected.

<Operation>

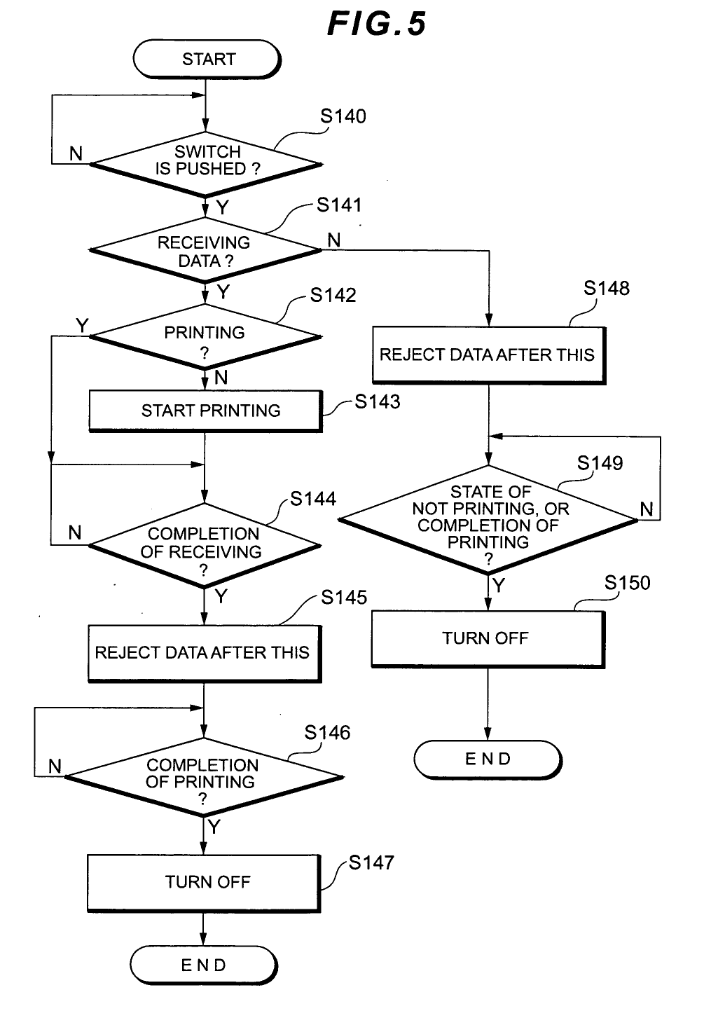

Hereinafter, an operation of Embodiment 2 is described referring to a flow chart of FIG. 5. In order to prepare for a maintenance work to be performed, the turning off arranging switch 6 is pushed by a maintenance staff (STEP S114). Thereby, a signal of arranging turning off of the image forming apparatus 1 is put out to the turning off controlling section 12. When the turning off controlling section 12 receives the signal, it starts a process of the present invention, and the turning off controlling section 12 inquires the interface section 7 whether it is receiving a data such as an image data etc. or not (STEP S141). When the interface section 7 is receiving a data, the process of the turning off controlling section 12 proceeds to the next step S142. When the interface section 7 is not receiving a data, the process of the turning off controlling section 12 proceeds to the step S148.

When the interface section 7 is receiving a data at step S141, the printing completion detecting section 3 detects whether a printing process is performed or not (STEP S142). When a printing process is not performed, the turning off controlling section 12 puts out an indicating signal to the printing section 2 so as to perform a printing process (STEP S143). Succeedingly, at a step S144, whether the receiving completion detecting section 20 has detected a received signal or not, and whether the storing completion detecting section 21 has detected EOF command or not; are judged by the turning off controlling section 12. When the turning off controlling section 12 has confirmed the EOF command and the received signal, it puts out a signal for indicating not to receive any other signal (STEP S145). In a state of rejecting any other signal, the expanding completion judging section 15 judges whether a process of expanding data corresponding to the EOF command inputted in the editing section 11 has completed or not. When the process has not completed, it is confirmed and a stopping signal is put out to the data editing section 11 so as to stop the expanding process. Then, in case where the printing section 2 is performing printing, the process of the turning off controlling section 12 waits for stop of the printing section 2 after the printing to be completed (STEP S146). After confirming all the data corresponding to the EOF command is printed, the turning off controlling section 12 puts out a control signal for turning off the main electricity source 4, so as to stop power supply of the main electricity source 4 to the data processing section 10 and the printing section 2 (STEP S147).

Again, at step S142, when the printing section 2 is operating, the process of the turning off controlling section 12 proceeds to a step S144. There, the process waits until the printing operation ends (STEP S146). After confirming stop of the printing section 2 after completion of printing, the turning off controlling section 12 puts out a controlling signal for turning off the main electricity source 4, so as to stop supply of electricity source to the data processing section 10 and to the printing section 2 (STEP S147).

Moreover, when no signal has been detected at the step S141, the process proceeds to a step S148. There, receiving any other data is rejected from now on. Succeedingly, the turning off controlling section 12 confirms that the printing section 2 is not operating. And, when it is confirmed, the turning off controlling section 12 puts out a signal V for turning off the main electricity source 4, so as to stop supply of electricity source to the data processing section 10 and to the printing section 2 (STEP S150).

<Effects>

According to Embodiment 2, effects are obtained as follows.

(a) When the printing section is operating, the printing section is stopped after confirming each EOF command of the received data. Therefore, the printing section operates as long as possible. Thereby, necessary capacity of the memory section for storing the received data, becomes small.

(b) Moreover, time for starting printing when a new data is received after the maintenance work is finished, becomes short; because the old received data stored in the memory section is small, and time for printing this data when the power switch is turned on again becomes short.

### <EMBODIMENT 3>

<Configuration>

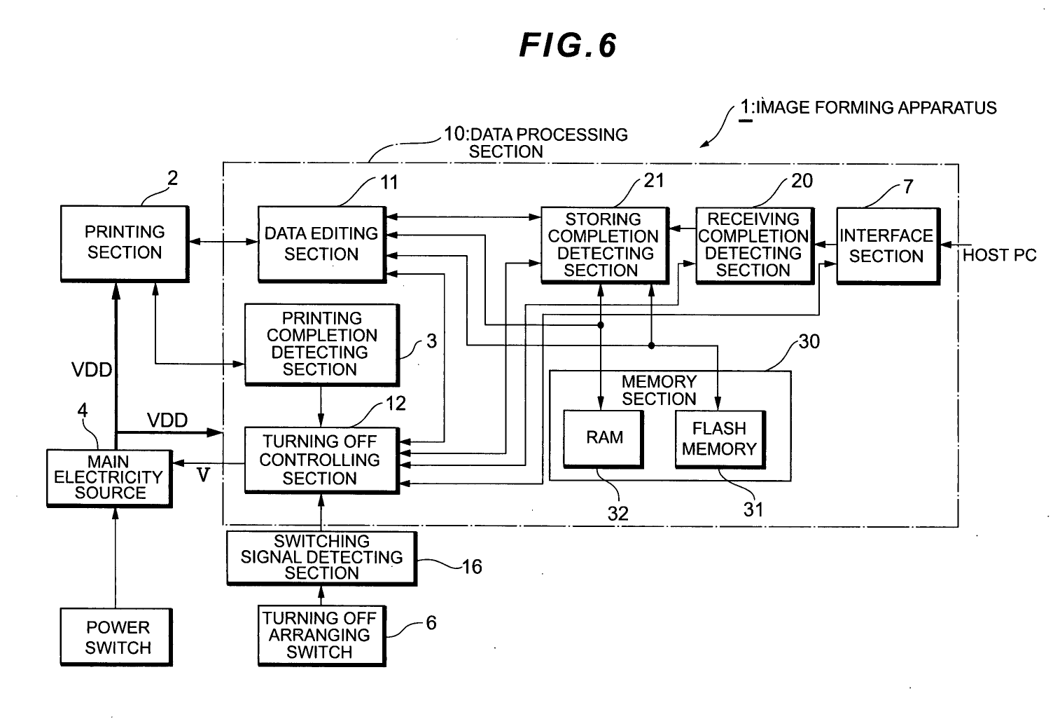

FIG. 6 is a block diagram showing a configuration of an image forming apparatus of Embodiment 3 which is based on Embodiment 1 mentioned above. In Embodiment 3, each of blocks shown in FIG. 6 same as Embodiment 1 or 2, are designated with the same symbol so as to omit the same description. In this case, the image forming apparatus of Embodiment 3 is installed with a switching signal detecting section 16 for detecting turning on or off of the turning off arranging switch 6.

<Operation>

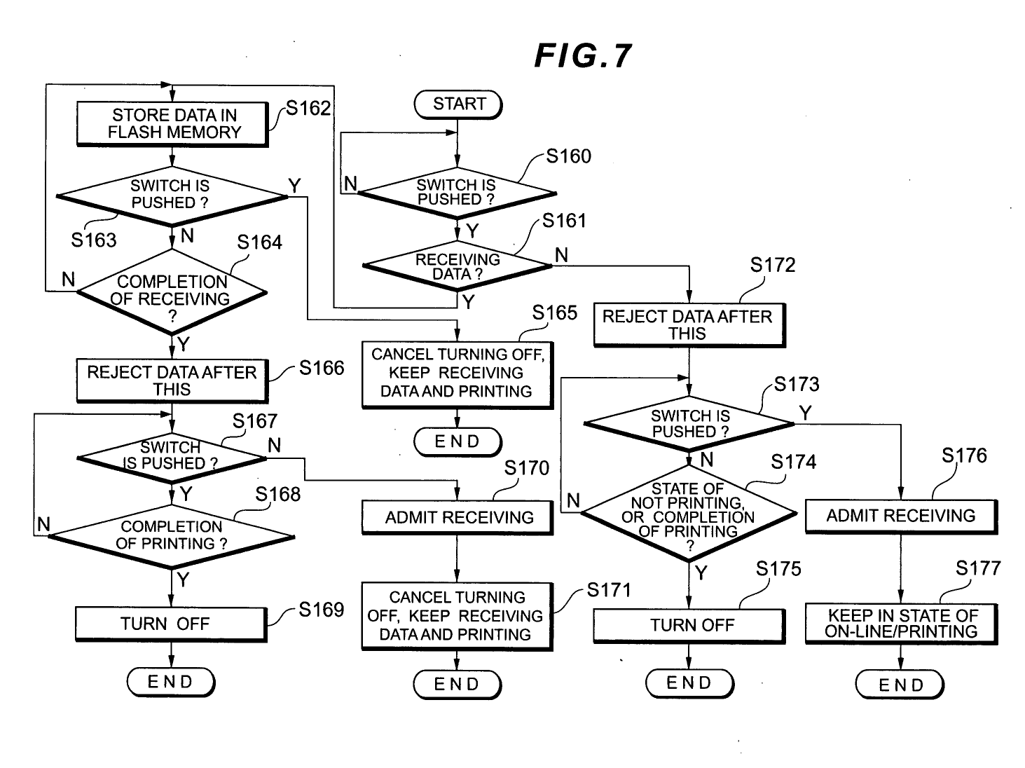

Hereinafter, an operation of Embodiment 3 will be described referring to a flow chart of FIG. 7. In order to prepare for a maintenance work to be performed, the turning off arranging switch 6 is pushed by a maintenance staff (STEP S160). Thereby, the switching signal detecting section 16 detects a signal of arranging turning off of the image forming apparatus 1. And, a detecting signal of the switching signal detecting section 16 is put out to the turning off controlling section 12. When the turning off controlling section 12 receives the signal, it confirms an intention of starting a maintenance work. Then, the turning off controlling section 12 starts a process of the present invention, and it inquires the interface section 7 whether it is receiving a data such as an image data etc. or not (STEP S161). When the interface section 7 is receiving a data, the process of the turning off controlling section 12 proceeds to the next step S162. When the interface section 7 is not receiving a data, the process of the turning off controlling section 12 proceeds to the step S172.

When the interface section 7 is receiving a data at the step S161, the receiving data is stored in the flash memory 31 of the memory section 30 (STEP S162). Subsequently, whether the turning off arranging switch 6 is pushed or not, is judged, again, at a step S163. When pushing the turning off arranging switch 6 is judged, the turning off controlling section 12 puts out an instruction of stopping its process of turning off the image forming apparatus 1. Then, it continues receiving the data to store in the flash memory 31 of the memory section 30. And, it sends the stored data to the editing section 11. Then, print data put out from the editing section 11 is printed out by the printing section 2 (STEP S165). When pushing the turning off arranging switch 6 is not judged at the step S163, the storing completion detecting section 21 confirms an EOF command of data stored in the flash memory 31, and it checks based on information from the receiving completion detecting section 20 whether receiving data is completed (STEP S164). When the storing completion detecting section 21 confirms an EOF command in the flash memory 31, and when the turning off controlling section 12 confirms detection of completion of receiving data, the turning off controlling section 12 puts out a signal for the interface section 7 to indicate not to receive any other data (STEP S166).

Here, again, pushing the turning off arranging switch 6 is watched (STEP S167). When pushing the turning off arranging switch 6 is detected by the switch signal detecting section 16, succeedingly whether printing by the printing section 2 is finished or not is checked (STEP S168). When the printing completion detecting section 3 has detected stop of the printing section 2 after completion of printing, the turning off controlling section 12 puts out a control signal for turning off the main electricity source 4, so as to stop power supply of the main electricity source 4 (STEP S169). When it is not detected that the turning off arranging switch 6 is pushed at the second attempt of the step S167, the turning off controlling section 12 indicates the interface section 7 to admit receiving data (STEP S170). After this, the process of turning off the image forming apparatus 1 is abandoned. Then, data is continuously received. The data temporarily stored in the flash memory 31 is read out to send to data editing section 11. Therefrom, print data is put out to perform printing (STEP S171).

When the interface section 7 is not receiving a data at step S161, the turning off controlling section 12 puts out an indicating signal to the interface section 7 of not receiving data any more (STEP S172). Succeedingly, pushing the turning off arranging switch 6 is watched (STEP 173). When pushing is detected by the switch signal detecting section 16, receiving data is admitted (STEP S176). When the turning off arranging switch 6 is not pushed, the printing section 2 is in a state of not printing or in a state of completed printing, is watched (STEP S174). When either of the states are detected, the turning off controlling section 12 puts out a control signal V for turning off the main electricity source 4, so as to stop power supply of the main electricity source 4 to the data processing section 10 and to the printing section 2 (STEP S175). Moreover, at the step S173 mentioned above, when the switch signal detecting section 16 detects that the turning off arranging switch 6 is pushed, the turning off controlling section 12 indicates the interface section 7 to admit receiving data (STEP S176). Thereby, in case where the printing section 2 is printing, it continues printing; and in case where the printing section 2 is not printing, it is set to a state of waiting for print job (STEP S177).

<Effects>

According to Embodiment 3, effects are obtained as follows.

(a) By detecting that the turning off arranging switch 6 is pushed again, a process of turning off the main electricity source 4 indicated by the turning off controlling section 12 for a maintenance work, can be canceled.

### <EMBODIMENT 4>

<Configuration>

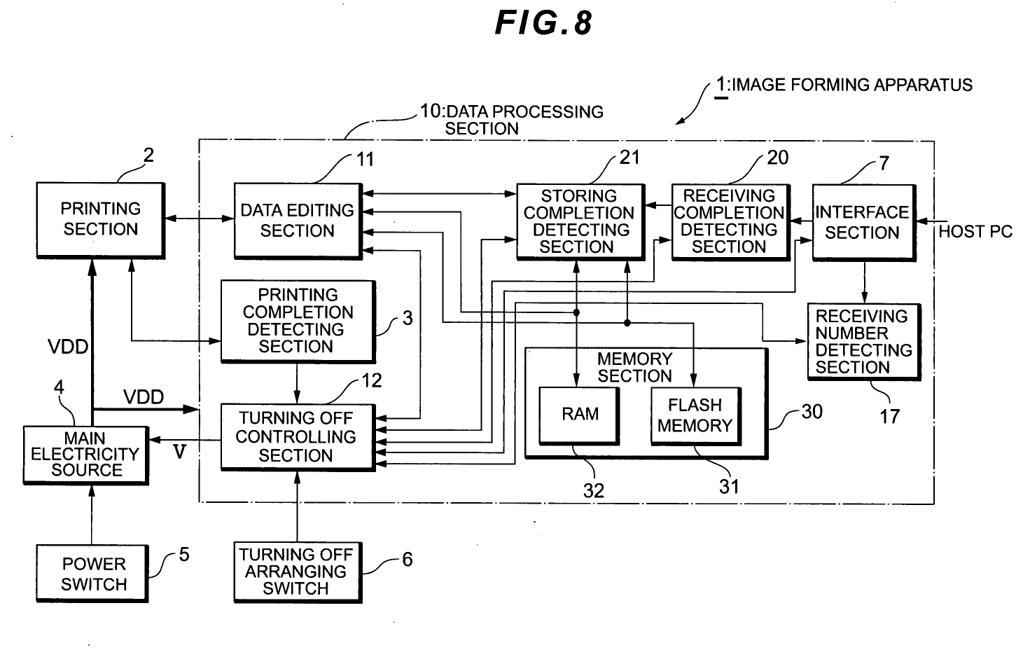

FIG. 8 is a block diagram showing a configuration of an image forming apparatus of Embodiment 4 which is based on Embodiment 1 mentioned above as well. In Embodiment 4, each of blocks shown in FIG. 8 same as Embodiment 1, 2 or 3, are designated with the same symbol so as to omit the same description. In this case, the image forming apparatus of Embodiment 4 is installed with a receiving number detecting section 17 connected with the interface section 7 for detecting the number of data sent from a host computer.

<Operation>

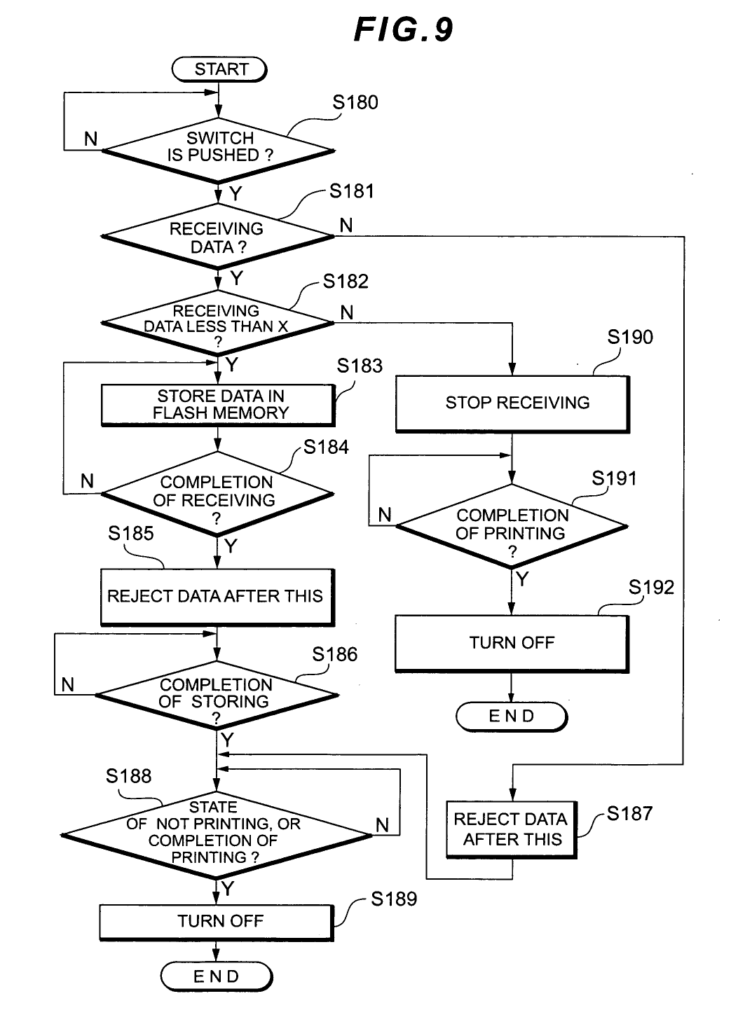

Hereinafter, an operation of Embodiment 4 will be described referring to a flow chart of FIG. 9. In order to prepare for a maintenance work to be performed, the turning off arranging switch 6 is pushed by a maintenance staff (STEP S180). Thereby, a signal of arranging turning off of the image forming apparatus 1 is put out to the turning off controlling section 12. When the turning off controlling section 12 receives the signal, it starts a process of the present invention, and it inquires the interface section 7 whether it is receiving a data such as an image data etc. or not (STEP S181). When the interface section 7 is receiving a data, the receiving number detecting section 17 detects the number of data received at the interface section 7, and it sends a data number signal to the turning off controlling section 12. Then, the turning off controlling section 12 calculates the number of the receiving data from the data number signal, and it judges whether the number of the receiving data is less than a prescribed number X, or, more than or equal to the prescribed number X (STEP S182). In case where the number of the receiving data is less than a prescribed number X, the receiving data is received by the number, and stored temporarily in the flash memory 31 (STEP S183). In case where the number of the receiving data is more than or equal to the prescribed number X, the process of the turning off controlling section 12 proceeds to a step S190.

In case where the number of the receiving data is less than the prescribed number X at STEP S182, the receiving data is stored in the flash memory 31. After this, the turning off controlling section 12 confirms EOF command of each data, and it inquires to receiving completion detecting section 20 whether receiving data is completed or not (STEP S184). When EOF command is confirmed and data receiving is judged, the turning off controlling section 12 puts out a signal for the interface section 7 to indicate not to receive any other data. Succeedingly, the data storing detecting section 21 inquires to the memory section 30 whether storing the receiving data is completed or not (STEP S186). When completion of storing is judged, the process of turning off proceeds to a step S188. Then, the turning off controlling section 12 inquires to the printing completion detecting section 3 whether the printing section 2 is performing printing or it has completed printing or not. When the turning off controlling section 12 is informed of not printing or of completing printing, it puts out a controlling signal V for stopping power supply from the main electricity source 4 to the data processing section 10 and to the printing section 2 (STEP S189).

On the other hand, in case where the number of the receiving data is more than or equal to the prescribed number X at the step S182, the turning off controlling section 12 quickly stops receiving data at the step S190. Succeedingly, the turning off controlling section 12 inquires to the printing completion detecting section 3 whether printing by the printing section 2 is performed or not (STEP S191). When the printing completion detecting section 3 has detected completion of printing, the turning off controlling section 12 puts out a control signal V for turning off the main electricity source 4, so as to stop power supply of the main electricity source 4 (STEP S192).

<Effects>

According to Embodiment 4, effects are obtained as follows.

(a) When turning off of the main electricity source is arranged in order to perform a maintenance work, the number of the receiving data at the interface section is detected by the receiving number detecting section 17 so as to cancel the arrangement of turning off in case where the number of the receiving data exceeds a prescribed number X, which is set beforehand based on the user's intention. Therefore, the image forming apparatus becomes further easier to use.

### <EMBODIMENT 5>

<Configuration>

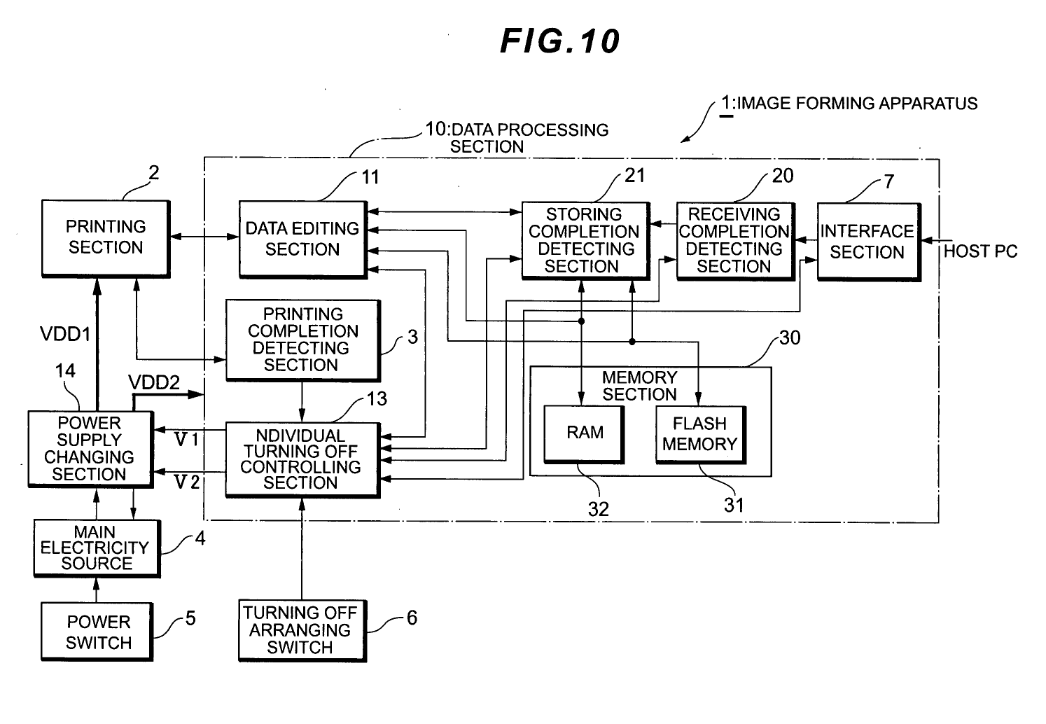

FIG. 10 is a block diagram showing a configuration of an image forming apparatus of Embodiment 5 which is based on a second invention. In Embodiment 5 of the second invention, each of blocks shown in FIG. 10 same as each Embodiment mentioned above, are designated with the same symbol so as to omit the same description. In the image forming apparatus of Embodiment 5, the data processing section 10 is newly installed with an individual turning off controlling section 13, and a power supply changing section 14 for controlling power supply from the main electricity source 4 by a controlling signal put out from the individual turning off controlling section 13. Thereby the power supply changing section 14 changes individually between turn on and turn off, each supply of electric powers VDD1 and VDD2 from the main electricity source 4 to each of the data processing section 10 and the printing section 2.

<Operation>

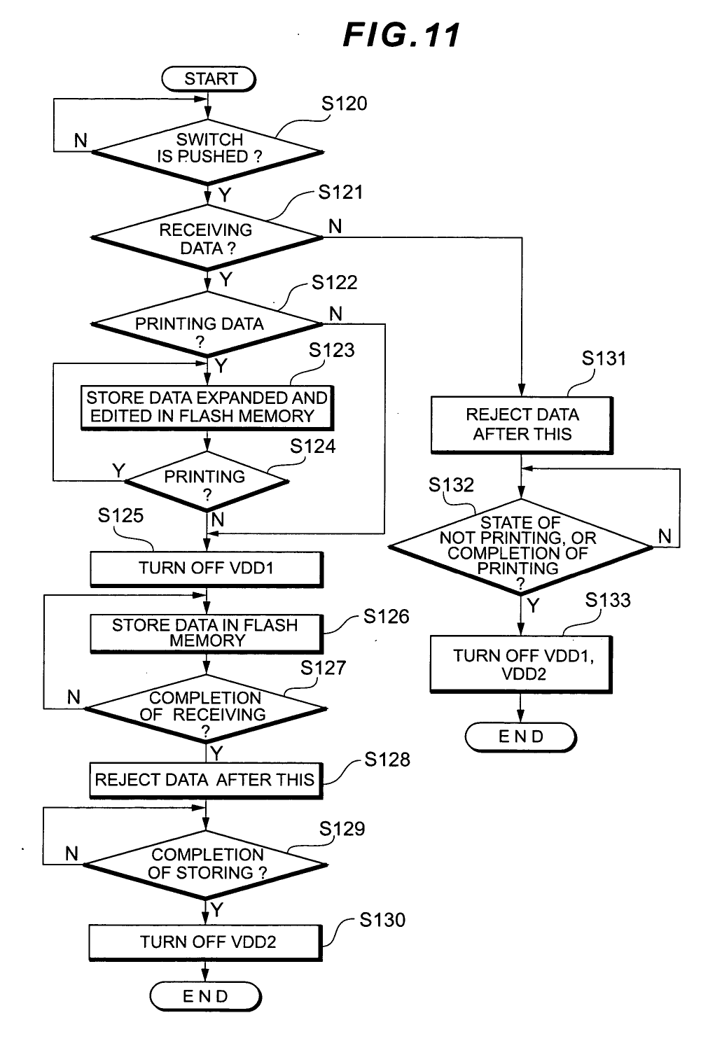

Hereinafter, an operation of Embodiment 5 will be described referring to a flow chart of FIG. 11. In order to prepare for a maintenance work to be performed, the turning off arranging switch 6 is pushed by a maintenance staff (STEP S120). Thereby, a signal of arranging turning off of the image forming apparatus 1 is put out to the individual turning off controlling section 13. When the individual turning off controlling section 13 receives the signal, it starts a process of the present invention, and it inquires the interface section 7 whether it is receiving a data such as an image data etc. or not (STEP S121). When the interface section 7 is receiving a data, the process of the individual turning off controlling section 13 proceeds to a step S122. When the interface section 7 is not receiving a data, the process of the individual turning off controlling section 13 proceeds to a step S131.

When the interface section 7 is receiving data at the step 121, and when the individual turning off controlling section 13 is informed of printing from the printing completion detecting section 3 which is watching the state of the printing section 3; the data editing section 11 stores the editing data in the flash memory 31 of the memory section 30 (STEP S123). Here, the editing data includes data not edited, with the edited data. Then, the individual turning off controlling section 13 judges whether the printing section 2 is operating or not. When the printing section 2 is operating, the process returns to the step S123 to repeat it. When it is detected that the printing section 2 has stopped after printing has ended, the individual turning off controlling section 13 detects this, and it puts out a controlling signal V1 to the power supply changing section 14 so as to stop power supply of the electric power VDD1 from the main electricity source 4 to the printing section 2 (STEP S125).

Succeedingly, it is continued to store the receiving data in the flash memory 31 of the memory section 30 (STEP S126). Then, the individual turning off controlling section 13 judges whether store of EOF command is completed (STEP S127). When it is not completed, the process proceeds to the step S126 to repeat this. When it is completed, the individual turning off controlling section 13 puts out a signal for the interface section 7 to indicate not to receive any other data. Succeedingly, the data storing detecting section 21 inquires to the memory section 30 whether storing the receiving data is completed or not (STEP S129). When completion of storing is judged, the individual turning off controlling section 13 puts out a controlling signal V2 to the power supply changing section 14 so as to stop power supply of the electric power VDD2 from the main electricity source 4 to the data processing section 10 (STEP S130).

On the other hand, in case where the interface section 7 is not receiving any data at the step S121, the individual turning off controlling section 13 rejects receiving data any more (STEP S131). Then, the individual turning off controlling section 13, after detecting completion of printing and stop of the printing section 2 at a step S132, puts out a control signal V1 to the power supply changing section 14 so as to stop supply of electric power VDD1 to the printing section 2 and supply of electric power VDD2 to the data processing section 10 (STEP S133). Thus, the individual turning off controlling section 13 stops all power supply of the main electricity source 4 to the image forming apparatus 1.

<Effects>

According to Embodiment 5, effects are obtained as follows.

(a) Before beginning a maintenance work, the turning off arranging switch 6 is pushed, it is judged whether the printing section 2 is operating or not. Then, the data editing section 11 stops putting out print data to the printing section 2 at a nearest boundary of each page of the received data. And, the individual turning off controlling section 13, after detecting that printing has completed, turns off power supply to the printing section 2.

(b) Moreover, the rest of the received data which is being expanded in the editing section 11, is kept being stored in the memory section 30. And, the receiving data which is being received after detecting an EOF command, is rejected. Thereby, even when the received data has a large volume, the printing section 2 is quickly stopped by stopping power supply to the printing section 2 before stopping power supply to the data processing section 10, as the electricity source changing section 14 operates based on an indication from the individual turning off controlling section 13. Therefore, saving the power supply is realized.

1. An image forming apparatus operated with receiving power supply from a main electricity source, and having a data processing section for sending the received data put out from a host apparatus to a printing section after processing the received data to print data, comprising:
an electricity source changing section for turning on or off said main electricity source;
a turning off arranging signal generating section for putting out a signal for arranging turning off said main electricity source;
a memory section for storing the received data;
a data editing section for reading out said received data from said memory section, and for editing said received data, so as to put out print data;
a data storing detecting section for detecting completion of storing said received data in said memory section;
a printing completion detecting section for detecting stop of said printing section after completion of printing data in said printing section; and
a turning off controlling section for starting a process for turning off the image forming apparatus, with receiving said signal from said turning off arranging signal generating section, and for stopping power supply from said main electricity source, with receiving a signal from said receiving completion detecting section informing of completion of receiving, and with receiving a signal from said printing completion detecting section informing of completion of printing.

2. An image forming apparatus according to claim 1 further comprising:
an expanding completion judging section for putting out a signal to said data editing section for stopping process of expanding and editing, at receiving a signal of arrangement of turning off made by said turning off controlling section, after receiving information from said receiving completion detecting section informing of completion of receiving.

3. An image forming apparatus according to claim 1 further comprising:
a canceling signal detecting section for detecting a canceling signal of canceling said signal of turning off generated from said turning off arranging signal generating section.

4. An image forming apparatus according to claim 1 further comprising:
a receiving number detecting section for detecting the number or quantity of the received data.

5. An image forming apparatus according to claim 4 wherein:
said turning off controlling section has a reference number or quantity, for turning off said main electricity source, based on the number or quantity of the received data detected by said receiving number detecting section.

6. An image forming apparatus according to claim 1 wherein:
said memory section has a non-volatile memory.

7. An image forming apparatus according to claim 1 further comprising:
a receiving data rejecting section for rejecting data sent from said host apparatus at receiving a signal of arrangement of turning off.

8. An image forming apparatus according to claim 1 further comprising:
a data receiving admission judging section for judging whether the data receiving admission judging section admits receiving data sent from said host apparatus again after receiving a signal of arrangement of turning off.

9. An image forming apparatus according to claim 8 further comprising:
an operating section for generating said signal of arrangement of turning off;
wherein said data receiving admission judging section admits receiving data sent from said host apparatus again when said operating section is operated after said signal of arrangement of turning off is generated.

10. An image forming apparatus operated with receiving power supply from a main electricity source, and having a data processing section for sending the received data put out from a host apparatus to a printing section after processing the received data to print data, comprising:
an electricity source changing section for turning on or off said main electricity source;
a turning off arranging signal generating section for putting out a signal for arranging turning off said main electricity source;
a memory section for storing the received data;
a data editing section for reading out said received data from said memory section, and for editing said received data, so as to put out print data;
a data storing detecting section for detecting stop of said printing section after completion of storing said received data in said memory section;
a printing completion detecting section for detecting completion of printing data in said printing section;
an individual turning off controlling section for starting a process for turning off the image forming apparatus, with receiving said signal from said turning off arranging signal generating section, and for stopping power supply from said main electricity source, with receiving a signal from said receiving completion detecting section informing of completion of receiving, and with receiving a signal from said printing completion detecting section informing of completion of printing; and
an electricity source changing section for changing power supply from said main electricity source between said data processing section and said printing section.

11. An image forming apparatus according to claim 10 wherein:
said memory section has a non-volatile memory.

12. An image forming apparatus according to claim 10 wherein said individual turning off controlling section comprising:
a first turning off controlling section for turning off power supply to said printing section when said printing section has stopped after receiving said signal of arrangement of turning off; and
a second turning off controlling section for turning off power supply to said data processing section after judging completion of receiving data, when said printing section has stopped after receiving said signal of arrangement of turning off.
